(19) United States
(12) Patent Application Publication
(10) Pub. No.: US 2007/0063013 A1
(43) Pub. Date: Mar. 22, 2007

(54) Systems and methods for maintaining warranty claim information

(75) Inventors: Raymond Michael Marowski, Lexington, KY (US); Evan James Powers, Lexington, KY (US); Mark Stephen Underwood, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/230,191

(22) Filed: Sep. 19, 2005

(51) Int. Cl. G06F 17/00

(52) U.S. Cl. 235/375

(57) ABSTRACT

An image forming system such as a printer (100) includes an RFID tag (70) and RFID reader (72) for storing one or more warranty parameters. A print controller (57) measures a specified warranty parameter and causes the reader (72) to write data representative of the parameter to the RFID tag (70). The data may be encrypted for security. Later, an external RFID reader (74) may be used by service personnel to retrieve the data from the RFID tag (70) for processing a warranty claim.

### TECHNICAL FIELD

The present invention relates to the processing of warranty claims for items submitted for warranty coverage. More particularly, the invention relates to the automated storage and retrieval of information related to warrantable items for facilitating warranty coverage of such items. Still more particularly, the invention provides a system using RFID technology to store one or more warranty parameters related to a warrantable item on a radio frequency readable memory device, such as an RFID tag, making warranty related information available for later access by service personnel.

### BACKGROUND OF THE INVENTION

A significant factor in the cost to the maker of an electronic or electro-mechanical device is the expense of honoring warranty claims. Today, many such devices comprise complex systems with many subassemblies and internal components which may have different life expectancies or service/maintenance cycles. For components having a known life expectancy, warranty conditions often apply only for the expected life of the device. In the case of complex systems such as a laser printer, there may be serviceable subassemblies whose life is measured differently from the rest of the machine. For example, the life warranty serviceability of most components of a laser printer may be measured in years, while the life of the fuser subassembly inside the printer may be measured in the number of pages printed. Likewise, in the case of thermal printers, the printhead life is measured in the number of inches of media fed through the printhead. Other examples may include the toner cartridge, document feed rollers, ink jet printheads and any other subassembly whose wear over time may cause the item to fail or mandate routine service.

Because these subassemblies may be quite expensive to replace, it is desirable that the validity of a warranty claim be verified as soon as practical. These subassemblies may be designed to be field and/or customer replaceable. If the item may be replaced by the customer it may be advantageous to only require return of the subassembly to the manufacturer to support a warranty claim. It is therefore useful that the information required to support the warranty claim, such as page count or operating hours, for example, be stored in an easily accessible manner on the device or faulty subassembly for retrieval by service personnel, either in the field or at a service center.

Thus, a means of storing and reading warranty claim information directly from a part submitted for warranty coverage would be advantageous.

### BRIEF DESCRIPTIONS OF THE DRAWINGS

The present invention is illustrated by way of example and not limitation in the figures of the accompanying drawings in which like references indicate similar elements, and in which:

FIG. 1 is a block diagram of the major components of an ink jet printer constructed according to the principles of the present invention;

FIG. 2 is a block diagram of a system for storing, reading and processing warranty claim information according to the invention; and

FIG. 3 is a process flow diagram for a method of storing, reading and processing warranty claim information according to the invention.

### DETAILED DESCRIPTION

For simplicity the discussion below will use the terms “media”, “sheet” and/or “paper” to refer to a discrete unit of recording media. It should be understood, however, that this term is not limited to paper sheets, and any form of discrete recording media is intended to be encompassed therein, including without limitation, envelopes, transparencies, postcards, labels, and the like.

The advent of radio frequency device technology such as Radio Frequency Identification (RFID) provides a means of attaching inexpensive electronic data storage to an object in a way that does not interfere with the object's operation. In particular, a radio frequency based memory device, such as an RFID tag, provides a hands-free method of storing and accessing warranty data. The present invention provides a means of using radio frequency device technology to store warranty claim information on a system, device or subassembly of the system so that service personnel can easily retrieve that information and act upon it as appropriate.

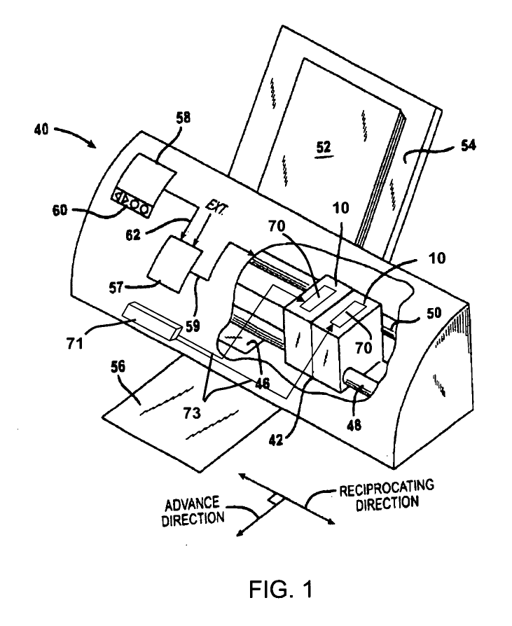

To better understand the invention, reference is made to FIG. 1 which illustrates a modern day complex electromechanical system in the form of an inkjet printer, denoted generally as 40, having one or more printheads 10 (the terms “printhead” and “printheads” will be used interchangeably throughout). It should be understood that while the invention is illustrated and described in the context of an inkjet printer, the concepts illustrated and described herein may be utilized in a wide range of applications where it is desired to efficiently obtain, process, verify and honor warranty claims. Thus, the present invention can be equally applied to other complex systems having devices, components and/or subassemblies that may be submitted for warranty coverage. Such systems may include, without limitation, laser printers, thermal printers, facsimile machines, and copiers, computers, etc. . . , for example.

A brief overview as to how an inkjet printer operates. As is well known in the arts, printheads 10 may be situated on a carriage 42 which reciprocates in accordance with an output 59 of a controller 57 along a shaft 48 above a print zone 46 by a motive force supplied to a drive belt 50. The reciprocation of the carriage 42 occurs relative to a print medium, such as a sheet of paper 52 that advances in the printer 40 along a paper path from an input tray 54, through the print zone 46, to an output tray 56.

Thus, during a printing operation, the carriage 42 of the printer 40 reciprocates in the reciprocating direction generally perpendicularly to the paper 52 being advanced in the advance direction as shown by the arrows. Ink drops from a compartment (not shown) may be ejected from a heater chip 25 at such times pursuant to commands of a printer microprocessor or other controller 57. The timing of the ink drop emissions corresponds to a pattern of pixels of the image being printed. Often times, such patterns become generated in devices electrically connected to the controller 57 that reside externally to the printer and include, but are not limited to, a computer, a scanner, a camera, a visual display unit, a personal data assistant, or other (not shown).

To print or emit a single drop of ink, a plurality of fluid firing elements are uniquely addressed with a small amount of current to rapidly heat a small volume of ink. This causes the ink to vaporize in a local ink chamber between the heater and the nozzle plate and eject through, and become projected by, the nozzle plate towards the print medium. The fire pulse required to emit such ink drop may embody a single or a split firing pulse and is received at the heater chip on an input terminal (e.g., bond pad 28) from connections between the bond pad 28, the electrical conductors 26, the I/O connectors 24 and controller 57. Internal heater chip wiring conveys the fire pulse from the input terminal to one or many of the fluid firing elements.

Having described the basic operation of an inkjet printer, such as printer 40, it should be apparent the various subassemblies of such a complex device are susceptible to failure over use. For example, the printhead 10 may need replacement after an approximate number of sheets of paper 52 are fed through the printhead 10. Typically each printhead 10 has an expected life and should the printhead 10 (or any other warrantable item of printer 40) fail before its expected and warrantable life, the item may be submitted under a warranty for service or replacement.

It is known that one type of replaceable printhead (as in a thermal printer, for example) may have an expected life of 600,000 inches of media fed through the printhead. A printer, such as printer 40, may have the capability to measure the media fed through the printhead 10 as the media is printed upon. With this capability or other similar function, the printer 40 may allow the measurement of a warranty parameter in various ways such as, for example, by counting the number of revolutions of either the transport motor or one of the media feed rollers, and translating the measurement to a linear distance traveled such as “mm” or “inches” of media fed through the printhead 10. After an error or at some predetermined life expectancy, the control panel 58 may generate a message informing the user the printhead 10 should be serviced or replaced. If a warranty condition exists on the printhead 10, the user can return it for service under a warranty claim.

For convenience, the printer may inform the user by displaying an error message through a panel, such as control panel 58 having user interface 60, that the printhead should be replaced.

Therefore, each warrantable item (such as printhead 10 or other warranty item of printer 40) may have an attached RFID tag 70 capable of storing information about the printhead which may be used to indicate how much media has passed through the printhead. For example, it is known that a readily available RFID tag could easily store numbers as large as 600,000. Such a value may be readily represented as a 24- or 32-bit stream which may be stored on virtually any of the commercially available RFID tags. Additional information may also be stored on the RFID tag 70, such as product or printhead serial number, date of manufacture, date of installation, printing duty cycle information, and so on. The distance measurement as stored in the tag 70 can be used to determine the age of the printhead 10.

A radio frequency data writing/reading device (also referred to as a data programmer) 71 may comprise an RFID reader of the type readily available in commerce. As shown, device 71 is operably coupled to tag 70 via signal paths 73 which represent signaling channels to each tag 70. The signal paths 73 may comprise physical signal lines to the tag 70. Alternatively, signal paths 73 may comprise an air interface to the tag 70. Likewise, tag 70 may include a dual port interface structure where one port is accessed via a wired interface and another port is accessed via an RF interface. Of course, it is well known that an RFID reader can program (i.e. write to or read from) an RFID tag through an air interface using well known radio frequency signaling techniques.

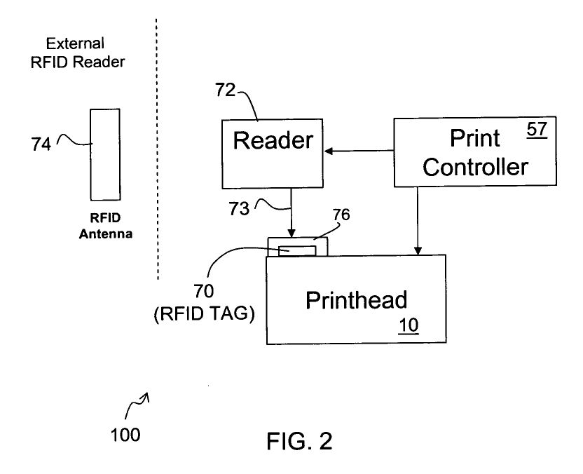

Referring to FIG. 2, a system for storing, reading and processing warranty claim information according to the invention is shown and denoted generally as 100. System 100 is shown configured to store warranty information about a printhead. It should be understood, however, that system 100 can be used for storing and retrieving information about numerous articles that may be subject to a warranty claim and where the retrieval of life/age information in order to assist in the handling of a warranty claim would be advantageous.

FIG. 2 shows a printhead 10 having an RFID tag 70 attached thereto. The RFID tag 70 can comprise any commercially available RFID tag in which information may be stored by a commercially available reader 72. The term reader is used generically to refer to any device capable of writing or reading data from a radio frequency readable memory device, such as tag 70. In this way, printer controller 57 can cause reader 72 to write age/use information on RFID tag 70 relating to the age or amount of use of printhead 10. Methods and devices for counting the amount of media that passed through printhead 10 are well known and, as such, will not be described here. The use of RFID tag 70, however, provides a way of storing information required to support warranty claims relating to a warranty item such as printhead 10. The information stored may include page count, operating hours, or other similar indicator of an item's age or amount of use.

Signal path 73 comprises the signal paths representative of both the input and output channels for writing to and reading from the RFID tag 70. In one embodiment, RFID tag 70 may comprises a dual port device allowing reader 72 to interface with RFID tag 70 via a wired input for writing data to RFID tag 70 and external reader 74 to read data from RFID tag 70 over an air interface.

As shown, printhead 70 may be placed in operable proximity to an RFID antenna 74 for reading the information stored on RFID tag 70. This can correspond to a service center accessing the information on the RFID tag 70 in order to verify a warranty claim. In this way, warranty information may be stored in an easily accessible manner on either the device or faulty subassembly for retrieval by service personnel, either in the field or at a service center. Additional information may also be stored on the RFID tag 70, such as product or printhead serial number, date of manufacture, date of installation, printing duty cycle information, and so on.

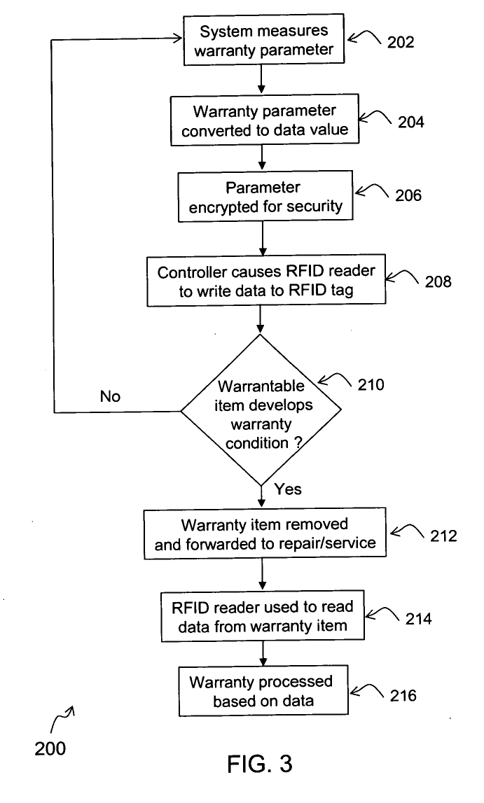

Referring to FIG. 3, a process flow diagram for a method of storing, reading and processing warranty claim information according to the invention is shown and denoted generally as 200. Process 200 begins at step 202 wherein a complex electromechanical system, such as printer 40, measures a specified warranty parameter. The warranty parameter may include, for example, the amount of media that has traversed the print area of a printhead, such as printhead 10, in an ink jet printer. Another example would include maintaining a count of the amount of toner used from a toner cartridge of the type typically used in a modern laser printer or copy machine. Still another example may include maintaining a count on the number of fusing operations performed by a fuser assembly in a printer or copier. Of course, it is contemplated that many other indicators of a component's prior use or life for many other types of components or subassemblies of many other types of electro-mechanical systems can be maintained.

Next, at step 204, the warranty parameter may be converted to a data value such as, for example, a digital bit stream indicative of the value measured. The parameter may be encrypted, step 206, for security to ensure it is not tampered with or destroyed. At step 208 a controller, such as controller 57, causes a radio frequency programmer, such as RFID reader 72, to write the data value representative of the warranty parameter to a radio frequency readable memory device such as RFID tag 70.

At step 208, it is determined if a warranty condition develops in the warrantable item. This may entail the occurrence of a defect in the warrantable item which the user may encounter or be informed of via the system's control panel. Alternatively, routine maintenance of the warrantable item may be required. Of course, other conditions may exist that require an item of the electromechanical system to be submitted for repair, maintenance or service. If a warranty condition has not occurred, process flow is redirected and steps 202, 204, 206 and 208 may be repeated to update the values stored in the radio frequency readable memory device.

If a warranty condition has occurred, process flow is directed to step 212 wherein the warranty item is removed from the system and sent to service personnel for repair and/or service. Since the radio frequency readable memory device is physically attached to the warrantable item, the data in the memory device is made available to service personnel. Next, at step 214, an external radio frequency reading apparatus, such as an appropriate RFID reader, is used by service personnel to access the data stored in the RFID tag. Finally, at step 216, the data obtained from the RFID tag is used to process the warranty claim related to the warrantable item.

Referring to FIG.2, RFID tag 70 may be secured to the printhead 10 in a tamper-proof or tamper-evident enclosure 76. The use of enclosure 76 may discourage a customer from defeating the security of system 100 and provide a service/repair facility with evidence if the system 100 has been tampered with. Also, the data on the RFID tag 70 may be electronically signed or encrypted to prevent electronic tampering, or the RFID tag 70 could be designed so as to guarantee that the value of its counter increases monotonically, thus preventing a customer from electronically “rolling back” the use or age count.

While any existing RFID system (RFID reader and corresponding RFID tag technology) may be suitable for use in system 100, the long range and high reader cost of UHF (900MHz) systems make them a less-than-optimal choice unless the electromechanical system already has a UHF reader installed for other reasons (such as for printing RFID-enabled media, for example). If so, the existing UHF reader can use an alternate antenna to read and write the RFID tag 70 during times when it is not actively programming RFID media. VHF (13.56 MHz) or HF (125 kHz) systems, however, may provide several advantages since the read/write ranges are very short, and particularly at HF frequencies, the RFID reader electronics are relatively low cost. Also, the RF antennas used can be made small and unobtrusive, and the very short read range can be used as a security enhancement.

It should be understood that modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system for maintaining warranty claim information pertaining to a warrantable item comprising:
radio frequency readable memory coupled to the warrantable item;
a data programmer for writing data to said radio frequency readable memory; and
processing means for measuring at least one warranty parameter associated with the warrantable item, said processing means in operable communication with said data programmer for causing said data programmer to write data representative of said warranty parameter to said radio frequency readable memory;
wherein said data representative of said warranty parameter may be utilized by service personnel in order to process a warranty claim for said warrantable item.

2. The system of claim 1 wherein said radio frequency-readable memory is radio frequency writeable and said data programmer comprises a radio frequency interface data programmer.

3. The system of claim 1 wherein said radio frequency readable memory is writeable from a wired interface and said data programmer comprises a wired interface data programmer.

4. The system of claim 1 wherein said radio frequency readable memory comprises an RFID tag.

5. The system of claim 4 further comprising an external RFID reader for reading said data from said RFID tag.

6. The system of claim 1 wherein said warrantable item comprises a printhead.

7. The system of claim 1 wherein said warrantable item comprises a fuser assembly.

8. The system of claim 1 wherein said warrantable item is a printhead for use in a printer and wherein said processing means comprises a controller within said printer.

9. The system of claim 8 wherein said controller measures the amount of media passing through a print area associated with said printhead.

10. The system of claim 9 wherein said radio frequency programmer comprises a RFID reader coupled to said printer and wherein said radio frequency readable memory comprises a RFID tag and wherein said controller causes said RFID reader to write data associated with a measure of the amount of media passing through a print area associated with said printhead to said RFID tag.

11. The system of claim 10 wherein said data is encrypted.

12. An image forming system supporting the maintenance of warranty claim information comprising:
a warrantable item providing an image forming function for said system;
a controller configured to measure at least one warranty parameter associated with said warrantable item;
a radio frequency readable memory device; and
a radio frequency programmer in operable communication with said controller and adapted for writing data to said radio frequency readable memory device;
wherein data representative of said warranty parameter may be written by said programmer to said memory device for future use by service personnel processing a warranty claim for said warrantable item.

13. The system of claim 12 wherein said radio frequency readable memory is radio frequency writeable and said data programmer comprises a radio frequency interface data programmer.

14. The system of claim 12 wherein said radio frequency readable memory is writeable from a wired interface and said data programmer comprises a wired interface data programmer.

15. The image forming system of claim 12 wherein said radio frequency readable memory device comprises an RFID tag.

16. The image forming system of claim 15 wherein said radio frequency programmer comprises an RFID reader.

17. The system of claim 16 wherein said RFID reader and RFID tag support VHF or HF RF communications.

18. The system of claim 12 wherein said data is encrypted.

19. The system of claim 12 wherein said warrantable item comprises a printhead and wherein said data represents the amount of media passing through a print area associated with said printhead.

20. The system of claim 12 wherein said warrantable item comprises a fuser assembly.

21. The system of claim 12 wherein said data further comprises information chosen from the group consisting of: serial number, date of manufacture, date of installation, printing duty cycle information.

22. A method of supporting the maintenance of warranty claim information comprising the steps of:
a controller of an electromechanical system making a measurement associated with at least one warranty parameter of a warrantable item;
a data programmer writing data associated with said measurement to a radio frequency readable memory device;
the warrantable item being submitted for warranty service;
reading said data from said radio frequency readable memory device; and
using the data to process the warrantable item under a warranty claim.

23. The method of claim 22 wherein said writing step is performed by said data programmer writing data to said radio frequency readable memory over a radio frequency interface.

24. The method of claim 22 wherein said writing step is performed by said data programmer writing data to said radio frequency readable memory over a wired interface.

25. The method of claim 22 further comprising the step continuously updating the data stored in said radio frequency readable memory device based on the occurrence of an activity adding life or usage to said warrantable item.

26. The method of claim 22 wherein said writing step is performed by an RFID reader in operable proximity to said memory device.

27. The method of claim 22 wherein said reading step is performed by an RFID reader that is external to said electro-mechanical system.

28. The method of claim 22 further comprising the step of the radio frequency reader writing data to said radio frequency readable memory device chosen from the group consisting of: serial number, date of manufacture, date of installation, printing duty cycle information.

29. The method of claim 22 wherein said writing step is performed by encrypting the data written to said radio frequency readable memory device.
